(19) United States
(12) Patent Application Publication
(10) Pub. No.: US 2003/0077430 A1
(43) Pub. Date: Apr. 24, 2003

(54) Nonwoven laminate material for mechanical closure systems, method for its production, and its use

(76) Inventors: Hansjorg Grimm, Weinheim (DE); Dieter Groitzsch, Hirschberg (DE); Peter Adam, Clarksville, TN (US)

Correspondence Address: KENYON & KENYON, ONE BROADWAY, NEW YORK, NY, 10004, US

(21) Appl. No.: 10/272,088

(22) Filed: Oct. 15, 2002

(30) Foreign Application Priority Data
Oct. 16, 2001 (DE) 101 51 045.74

(51) Int. Cl. B32B 1/00; D04H 1/54; B32B 27/14; D04H 3/14

(52) U.S. Cl. 428/198; 442/358; 442/382; 442/409; 156/166; 428/219; 428/903; 442/346; 442/350; 442/351

(57) ABSTRACT

A nonwoven laminate material for mechanical closure systems, method for its production, and its use. The multi-layer nonwoven fabric laminate material has at least one layer of a polyolefin endless filament nonwoven fabric having a maximum tensile strength in the machine running direction that is at least as great as crosswise to that direction, and made up essentially of fibers having a titer of less than 4.5 dtex, as well as a second layer of a nonwoven fabric that is bonded to the first layer, which includes a sheet of crimped staple fibers made of polyolefins, and whose crimped fibers are coarser than the fibers of the nonwoven fabric of the first layer. The at least two nonwoven fabric layers are bonded to one another at the common interface by bonding in the form of a pre-determined pattern. With this laminate, it is possible to produce diapers that are also suitable for adult incontinence patients, which have a mechanical closure system, e.g., a Velcro™ closure.

### BACKGROUND OF THE INVENTION

1. Field of the Invention

The present invention relates to a nonwoven laminate material. More particularly, the present invention relates to a nonwoven laminate material that can be used as a loop part for mechanical closure systems and that is highly resistant to tearing.

2. Description of Related Art

Mechanical closure systems are also referred to as Velcro closures. These closure systems have two components, the engagement part with a loop-like arrangement of the fibers or filaments, and the hook part made of extruded, single-hook, double-hook, and mushroom-shaped elevations. Such systems are also referred to as loop-and-hook closures or also as female and male parts of a mechanical closure.

Mechanical closure systems, instead of adhesive tapes, are increasingly being used in baby diapers and in protective undergarments for adults since mechanical closure systems demonstrate functional and price advantages as compared with adhesive tapes. For example, adhesive systems lose part of their adhesive capacity upon contact with fats and oils.

There are numerous existing configurations of the loop part of a Velcro closure in diapers and based on nonwoven fabrics or nonwoven laminate materials. For instance, U.S. Pat. Nos. 5,616,394, 5,611,791, and 5,643,397 describe a loop component that is made up of a polypropylene film (also referred to as “PP film” hereinafter) and a corrugated nonwoven fabric layer. The actual loop layer is made up of coarse polypropylene fibers. These fibers are autogenically heat-bonded to the film. The transparent film, which does not allow breathing, serves, at the same time, as a medium for heat-bonding the loop fibers, as a barrier layer against adhesive bleed-through, and as a surface for a multi-color printed design on the reverse. This problem solution is suitable for those cases whereby the loop component is glued onto a type of belt or tape and is therefore relatively small in area. No noticeable worsening of wearing comfort caused by the film is experienced with this particular configuration when wearing the diaper.

European Patent Application No. EP 774 909 describes a laminate of a nonwoven fabric. More specifically, this reference describes fixing a coarse fiber sheet in place on a stretched film, whereby after fixation, the film is then relaxed and therefore wave-shaped or other types of elevations in the third dimension are produced as loop media. Also in this case, the film additionally has the aforementioned three functions, in addition to its elasticity.

European Patent Application No. EP 765 616 describes a loop nonwoven fabric in which a mechanically or hydrodynamically needle-punched nonwoven fabric made of bicomponent binding fibers passes through a roller nip, in which one roller is heated above the melting point of the binding fibers and the other is clearly below the melting point of the same. Because of the temperature gradient, the one side is melted to form a film-like surface, and the other side remains unbonded at the surface. A gradient decrease in fiber melting takes place over the cross-section of the composite, from the film-like side to the actual loop side.

In the field of severe incontinence, diapers with Velcro closures are still being used today. Such diapers are usually provided with a belt made of nonwoven fabric/film laminate materials and an adhesive tape as a second part, as the closure system. However, mechanical closure system are not currently employed for this purpose, although the use of a mechanical closure system would be advantageous in light of the above.

The demands on a belt structured as a loop part over its entire area are very great. Because of the direct contact of the belt with human skin, the belt must be structured in such away, on the skin contact side, that skin irritations or even skin injuries are precluded. To maximize the comfort of the belt when worn, the belt should be able to breathe, e.g., it should be permeable for air, perspiration, and steam.

Of course, the side facing away from the body must demonstrate sufficient loop properties. In addition, such a belt should demonstrate a certain level of lateral rigidity, preventing it from rolling up while it is being worn. In addition, the belt should be soft and have a textile feel, and should be comfortable.

Also, in many cases, a high level of maximum tensile strength of the belt is desirable, for example in the case of severely incontinent patients. This is desirable, for instance, if the patient must be rolled to the side by the nursing personnel when applying the diaper. While the maximum tensile strength can be influenced, within certain limits, by increasing the width of the belt, the costs of the belt for a disposable article, on the one hand, and the diaper design, on the other hand, allow very little flexibility in determining the appropriate width of the belt. For a belt width between 4 and 6 cm, for example, a maximum tensile strength of approximately 60 to approximately 150 N/5 cm of strip width is required.

Nothing in the prior art suggests a satisfactory solution for providing a mechanical closure of a high-strength nonwoven fabric laminate material. The configurations described above, with a film cover on one side, are not sufficiently breathable (permeable), demonstrate a tendency to rustle under mechanical stress, and are not suitable for contact with the skin. The film-free configurations demonstrate rough surfaces that are not acceptable for contact with the skin, and are also insufficiently textile in feel. The fabric described in European Patent Application No. EP 765 616 is also unsuitable for use as a diaper for incontinent patients, because its melted base side, while porous, is still too much like a film.

### SUMMARY OF THE INVENTION

The present invention provides a nonwoven fabric laminate material that overcomes the disadvantages of the above-mentioned prior art references for the loop part of Velcro closures.

The present invention relates to a multi-layer nonwoven fabric laminate material that has at least one layer of a polyolefin endless filament nonwoven fabric, preferably a polypropylene endless filament nonwoven fabric, having a maximum tensile strength in the machine running direction that is at least as great as crosswise to that direction, preferably a ratio of 1:1 to 2.5:1, and made up essentially of fibers having a titer of less than 4.5 dtex, preferably in the range of 0.8 to 4.4 dtex, very especially preferably 1.5 to 2.8 dtex, as well as a second layer of a nonwoven fabric that is bonded to the first layer, which includes a sheet of crimped, preferably two-dimensionally and/or spirally crimped staple fibers made of polyolefins, and whose crimped fibers are coarser than the fibers of the nonwoven fabric of the first layer, and preferably have titer of 3.3 to 20 dtex, very particularly preferably 5.0 to 12.0 dtex, whereby the at least two nonwoven fabric layers are bonded to one another at the common interface by bonding in the form of a pre-determined pattern.

### BRIEF DESCRIPTION OF THE DRAWINGS

FIGS. 1(a) to 1(f) illustrate several examples of line-shaped engravings cross-wise to a machine running direction, in accordance with several embodiments of the present invention.

### DETAILED DESCRIPTION

According to one embodiment of the present invention, the crimped staple fibers of the sheet of the second nonwoven fabric layer demonstrate staple fibers made of olefin homopolymer or olefin copolymer or are blended from other materials, such as polyester, polyamide, or polyacrylonitrile, together with one or more additional fiber components of olefin homopolymer or copolymer.

In one embodiment of the present invention, the crimped fibers of the staple fiber layer of the second nonwoven fabric layer are coarser than those of the endless filament fiber layer of the first nonwoven fabric layer. The staple fibers of olefin homopolymer or copolymer, e.g., the multi-component fibers with proportions of olefin homopolymer or copolymer, may be a 100% component of the staple fiber layer or make up only part of the staple fiber layer. For the purpose of the highest possible closure strength with the hook part, at least 40% by weight of these fibers are advantageous.

In the production of the laminate material, according to one embodiment of the present invention, at least two different nonwoven fabric laying technologies are combined with one another. In this manner, the requirements for a belt used with adult diapers that can be worn by patients with severe incontinence are satisfied.

The connection between the at least two nonwoven fabric layers (referred to as “staple fiber layer and endless filament layer” hereinafter) is formed by adhesive bonding of the two layers at the common interface, in the form of a pre-determined pattern. In this regard, the polyolefin fiber components of both layers are preferably autogenically heat-bonded, such as by heat and pressure and/or by ultrasound.

The connection surfaces are made up of non-intersecting and preferably uninterrupted lines. These can be arranged parallel, in a mirror image, or offset relative to one another. The total connection area usually amounts to 10-40% of the total area, and is preferably 18 to 32% of the total area. The lines can be straight or can be curved in a regularly or irregularly repeated pattern. They can also be shaped as a regular or irregular zigzag. The orientation of the lines can be in the machine running direction, crosswise to the machine running direction, or at any desired angle between these two directions.

The nonwoven fabric laminate material according to the invention includes the fine-titer and coarse-titer nonwoven fabric layers described above. The endless filament nonwoven fabric can be produced according to known spun nonwoven fabric production methods. In this regard, the spun endless filaments are quenched with directed air streams and stretched before they are laid on a belt.

The spun nonwoven fabric is generally made up primarily of olefin fibers, preferably of polypropylene fibers and/or of fibers made of a copolymer of propylene and another polyolefin.

The spun nonwoven fabric is preferably stretched to its maximum, in order to achieve the greatest possible strength. Those laying methods that come as close as possible to isotropic fiber distribution are preferred. Especially preferred spun nonwoven fabric production methods are those that demonstrate a high level of mechanical crosswise strength due to pivoting of the endless filaments crosswise to the machine running direction.

The production conditions of the spun nonwoven fabric, such as die hole diameter, feed amount, and stretching conditions, are selected in such a way that fine fibers are formed, in the range indicated. The endless filaments of polyolefin may be free of hydrophilizing additives, or may be contain such additives melted into the fiber or applied to its surface. For use in diapers, however, it is advantageous if they demonstrate a water-repelling nature. In principle, the endless filaments can contain any known additives for the purpose of a change in properties in or on the fiber, such as fluorocarbon resins for the purpose of repelling dirt, or antimicrobial agents to prevent germ formation on the skin contact side. Lubricants or other agents for improving softness or feel can also be applied to the laminate material before or after lamination. The polyolefin endless filament layer can also be made up of multi-component fibers, preferably bicomponent fibers, or can contain such fibers, whereby one of the two components, specifically the outside one that is accessible to heat, is made up of polyolefin. In this case, however, the softening temperature, e.g., melting temperature of the outer component is selected in such a way that it is at least the same as that of the fibers, e.g., fiber components of the staple fiber layer that are to be bonded with it. Modification of the softening or melting range can be achieved in a known manner, by using an olefin copolymer. Because of the low stretching ratio of the endless filaments, which are preferably aerodynamically stretched, in comparison with the mechanically stretched staple fibers, the comonomer proportion in the copolypropylene of the spun nonwoven fabric can be lower than in the staple fiber.

The endless filament nonwoven fabric may have been additionally stretched before the production of the new laminate material, whereby usually lengthening in a preferential direction and a corresponding length reduction at a 90° angle to the preferential direction takes place. In this case, the fiber titer is not changed, or is only changed insignificantly.

Stretching preferably takes place crosswise to the machine running direction, in order to achieve an increase in strength in the crosswise direction, in a pre-determined manner. Such a measure can be particularly advantageous if the lengthwise/crosswise ratio of the maximum tensile strength values is greater than 1/1, such as 2/1 or even 2.5/1, for example.

The weight per unit area of the endless filament fiber layer is usually 15 to 60 g/m², preferably 25 to 45 g/m².

The second layer, which acts as the actual loop layer, includes crimped, e.g., two-dimensionally or spirally (helically) crimped staple fibers. The titer of these staple fibers is greater than the titer of the endless filaments in the first nonwoven fabric layer. As a rule, the titer ranges from 5.0 to 12.0 dtex.

The weight per unit area of the second nonwoven fabric layer is generally 15 to 70 g/m². In a preferred embodiment, the weight per unit area of the second nonwoven fabric layer is 20 to 50 g/m². The total weight per unit area of the laminate material is generally 30 to 130 g/m². In a preferred embodiment, the total weight per unit area of the laminate material is 45 to 95 g/m².

The crimped staple fibers are made up of olefin homopolymer or olefin copolymer or of two or more fiber components of olefin homopolymer or olefin copolymer. A core/mantle bicomponent fiber may also be comprised of a polypropylene core and a copolypropylene mantle with a lower melting point, for example. Such a bicomponent structure, which can also have a side-by-side configuration, is especially preferred, since it is more advantageous in cost than a single-component fiber of 100% copolypropylene.

The staple fibers of olefin homopolymer or olefin copolymer, e.g., the multi-component fibers with a polymer or copolymer proportion, may be a 100% component of the staple fiber layer or only part of the staple fiber layer. To achieve high laminate strength values, and therefore also high shear strength values after closure with the hook material, and to achieve high peel strength values when loosening the closure, the proportion of staple fibers made of olefin homopolymer or olefin copolymer is preferably at least 40% by weight.

For the purpose of transporting away perspiration, this staple fiber layer is preferably structured to be hydrophilic. Specifically, this staple fiber layer is preferably structured such that the fibers or a portion of them are covered with hydrophilic fiber preparations and/or that hydrophilizing additives are melted into the fiber. In the latter case, the hydrophilic additives impart hydrophilia to the fibers by migrating to the fiber surface. Fluid transport can also be accomplished by a blend with hydrophilic fibers, such as with cellulose, cotton, lyocell, or wool. In this case, the blend of hydrophilic fibers is advantageously in an amount, as known to a person skilled in the art, such that the laminate strength values are not worsened excessively. The maximum proportion of such absorbent, non-thermoplastic fibers is advantageously equal to or less than 40% by weight, and is preferably 25% by weight.

The staple fiber layer is preferably heat-bonded to the endless filament fiber layer only autogenically. In the case of multi-component fibers, these can be additionally heat-bonded with one another by melting the components with a lower melting point. The increased bonding within this loop layer that occurs as a result results in higher shear and peel strength values, on the one hand, but to a deterioration of the textile properties and an increase in abrasiveness on the loop side, on the other hand.

In a particular embodiment of the invention, the side of the first nonwoven fabric layer that lies opposite the second nonwoven fabric layer can additionally be comprised of a staple fiber sheet of preferably hydrophobic or hydrophobically activated crimped microfibers of polyolefins. For instance, the staple fiber sheet may be comprised of polypropylene (“PP”), propylene copolymer (“CoPP”), or bicomponent fibers with one or both of these components. Such a three-layer laminate nonwoven fabric will be employed, for example, if the requirements with regard to softness and skin friendliness are particularly high.

An additional increase in wearing comfort on the side facing the skin can also be achieved with a special endless filament nonwoven fabric that is structured explicitly from bicomponent fibers with at least one PP or CoPP component. Also, an additional increase in wearing comfort on the side facing the skin can also be achieved with a special endless filament nonwoven fabric that has an asymmetrical fiber cross-section configuration with regard to its two components, and that undergoes spiral crimping during the spinning process, by stretching the filaments with the directed air streams.

The invention also relates to a method for the production of the laminated material described above. This method may, according to one embodiment of the present invention, include the step of producing, in a known manner, a first layer of a polyolefin endless filament nonwoven fabric, having a maximum tensile strength in the machine running direction that is at least as great as crosswise to this direction. The method may also include the step of producing, in a known manner, a second layer of a nonwoven fabric, containing a sheet of crimped staple fibers of polyolefins, which are coarser than the fibers of the nonwoven fabric of the first layer. In addition, the method may include the step of bonding the first and the second layers of the nonwoven fabrics at the common interface, in the form of a pre-determined pattern.

In a preferred embodiment of the method of the present invention, the production of the laminate material is accomplished by the two fiber layers being autogenically heat-bonded with one another by calendering, e.g., by heat and pressure and/or by ultrasound. In the case of heat/pressure calendering, the calender roller pair is made up of a heated smooth roller and a roller having a line engraving, whereby the fine-titer side made up of endless filaments faces the smooth roller in the roller pressing nip. Production of the composite can take place in-line or in two separate steps. In the latter case, one of the two nonwoven fabric layers is preferably transformed into a more manageable form (that can at least be rolled up and unrolled), preferably by light preliminary bonding. It is practical if the endless filament nonwoven fabric is subjected to this very weak preliminary bonding, such as by embossing or pressing.

In this preferred embodiment, the endless filament fiber layer faces the smooth roller in the calender pressing nip, and serves as the soft, smooth, but not film-like textile side that, in the application as a belt for an adult diaper, faces the skin of the patient wearing the diaper.

This method, according to one embodiment of the present invention, is based on embossing calendering of a laminate material made up of at least two layers, with the composition already stated. At least one of the two or the three or the even more nonwoven fabric layers is made up of an endless filament nonwoven fabric.

Calendering to produce the laminate material results in autogenic heat-bonding of the fibers or fiber components that are melt-activated under the preliminary bonding conditions. Embossing calendering can take place by heat and pressure or by using ultrasound technology.

Autogenic heat-bonding is understood to mean heat-bonding of the affected fibers of the two or three layers with one another, e.g., without the addition of an additional adhesive.

In the embodiment of the present invention that employs calendering with heat and pressure, the heat-bonding temperatures are in the range of 110° C. to 155° C., depending on what olefin fiber or fiber component is being used. It is important that the calendering conditions be coordinated with the melting and softening behavior of the spun nonwoven fabric. Particularly when using a homofil endless filament nonwoven fabric, it is appropriate to select calendering conditions and, in particular, a heat-bonding temperature that causes only softening and deformation of the endless fibers, without melting them completely. This assures that no unintentional, disproportionately high loss in strength occurs in the spun nonwoven fabric, which is intended as a reinforcement layer.

The spun nonwoven fabric has generally been only weakly pre-bonded before it is transformed into a laminate material with a staple fiber sheet. This is understood to mean embossing bonding that results only in embossing of the engraving but not in heat-bonding or actual melting of the endless filament fibers. The use of a spun nonwoven fabric that has been heat-bonded thermally or by ultrasound, in a pattern, has proven to be less advantageous, since there is a risk that the PP spun nonwoven fabric can become brittle, hard, or damaged, and the textile properties can be severely impaired.

In the embodiment of the present invention in which calender lamination is employed to form the laminate material, by heat and pressure, at least one engraved and one smooth roller are generally used, so that uninterrupted heat-bonding lines that do not intersect are produced over the entire area of the goods.

In the case of a two-layer nonwoven fabric laminate, the spun nonwoven fabric is run against the smooth calender roller and undergoes soft but not film-like smoothing there. The staple fiber layer of crimped coarse fibers is accordingly run against the engraved roller. This results in undulations, the height of which depends primarily on the engraving depth and also on the recovery capacity of the fibers.

For the method according to the invention, engraving depths of 0.7 to 2.5 mm are practical. Preferably, the engraving depths are 0.9 to 1.6 mm.

The process of calender lamination can be followed by stretching in the machine running direction or crosswise to this direction, if necessary. Within the scope of the present specification, stretching is understood to mean reorientation of the fibers in the laminate material, and does not require that there be an increase in area after stretching is applied, nor that there be a reduction in the fiber diameter of the fibers involved in the laminate. Lengthwise or crosswise stretching is determined by the main orientation of the line-shaped heat bonds and the orientation of the staple fibers that form the loop layer. If the latter are oriented in the lengthwise direction, for example, it is advantageous if the heat bonds are preferably oriented crosswise or at least at an angle of less than 45° relative to the crosswise direction. In this case, stretching crosswise to the machine running direction should take place. It has turned out, in this manner, that the height of the loop undulations is increased thereby, and that engagement of the hooks is improved. Stretching is carried out at temperatures below the softening range of the autogenic heat bonds.

Bonding of the first and the second layer of the nonwoven fabrics at the common interface can take place in the form of different pre-determined patterns. Geometric shapes of the lines that stand out from the base of the engraving roller were already described above. The invention includes any type of pattern, for example line-shaped elevations that are applied to the base body of a roller and that extend without interruption over the entire roller width or roller length, without either making contact or intersecting at any roller surface.

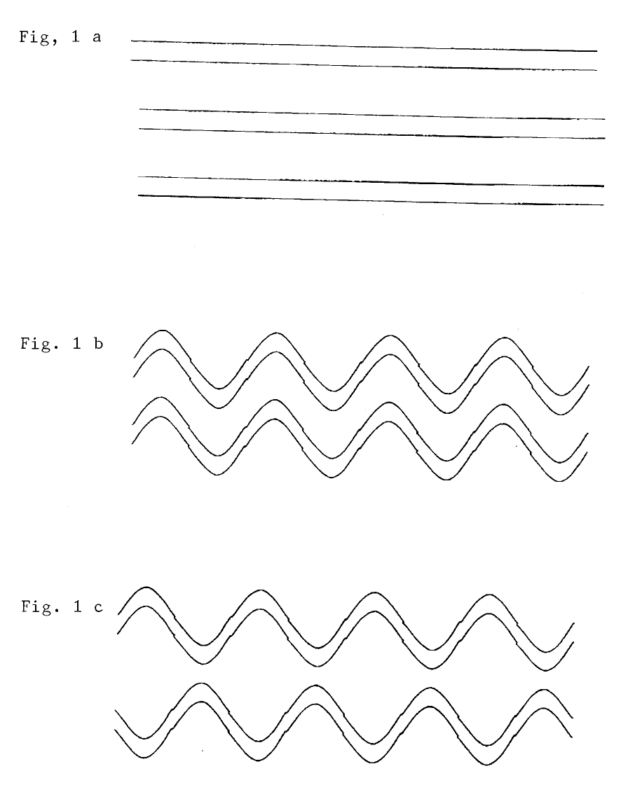

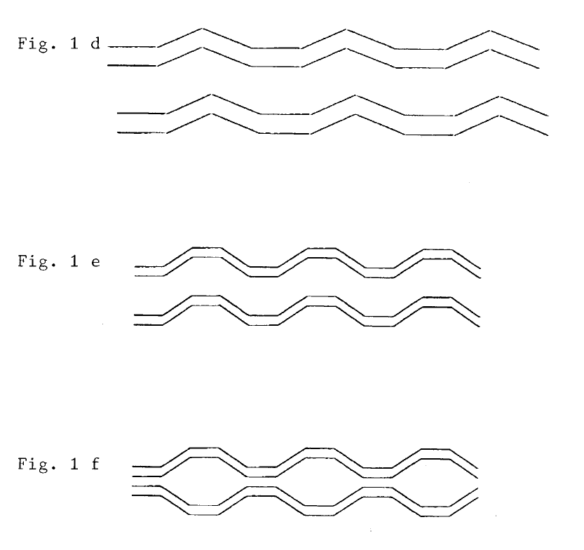

FIGS. 1(a) to 1(f) show some examples for line-shaped engravings crosswise to the machine running direction. The adjacent lines, arranged parallel in each instance, with the smaller distance between them, represent the heat-bonding areas, e.g., the elevations of the engraved calender roller surface.

The nonwoven fabric laminate materials, according to one embodiment of the present invention, may be generally used as loop components of Velcro closures for disposable products. Examples of uses for such disposable products are baby diapers, toddler diapers, and protective undergarments for adults. The new nonwoven fabric laminate material is particularly suited as a textile, breathable, skin-friendly belt material having a high level of tear strength in the lengthwise direction of the belt, with simultaneous loop properties for Velcro closures for adult patients with severe incontinence. Such patients are generally not able to put a diaper on or take it off themselves, and instead require outside assistance from nursing personnel. For this use, the belt must be structured to be so tear-resistant that the diaper can be pulled out from underneath the patient's body without being destroyed. These uses are also an object of the invention.

The second part of the mechanical closure system is the so-called hook part. This is usually a part produced by plastic extrusion, which is made up of a base plate and stems arranged perpendicular to it, the ends of which are made up of hooks, multiple hooks, or broadened round or square mushroom heads. The shape of the hooks or mushroom heads allows the fibers or loops of the loop part to be easily pushed aside, on the one hand, and to engage with them.

The following examples describe several embodiments of the present invention. However, it is noted that the present invention is not intended to be limited to or by these particular examples.

### EXAMPLE 1

Two staple fiber sheets (a) and (b) were laid on a conveyor belt. Staple fiber sheet (a) was made up of 100% crimped bicomponent fibers having a titer of 6.7 dtex, cut to a length of 60 mm, with a core/mantle configuration, made up of the components polypropylene as the core and polyethylene as the mantle, demonstrated a weight per unit area of 30 g/m², and was randomly laid in the machine running direction. Staple fiber fleece (b) was made up of 100% polypropylene fiber having a titer of 1.7 dtex, a cut length of 40 mm, and a sheet weight of 8 g/m². In contrast to sheet (a), it was laid in the machine running direction. A spun nonwoven fabric with a weight of 20 g/m², made of polypropylene, having an orientation that corresponded to a lengthwise/crosswise ratio of the maximum tensile strength of 1.3:1 and a fiber titer of 2.2 dtex, was placed between the two sheets crosswise to the machine running direction, and deflected in the machine running direction via a 45° angle deflection blade, and positioned between the two fiber sheets (a) and (b). The spun nonwoven fabric had been very lightly pre-bonded by embossing at minimum pressure and a temperature of only 135° C., before being introduced between the two staple fiber layers, and had thereby been brought into a state in which it was just possible to roll it up and unroll it.

The composite of these three loose layers, staple fiber sheet (a), polypropylene spun nonwoven fabric, and staple fiber sheet (b), was compressed in the nip between two smooth, non-heated steel rollers, after preliminary compacting. This facilitated feeding the composite to a calender, whose main elements included a heated smooth roller and a heated engraved steel roller.

The surface design of the engraved steel roller was made up of lines oriented parallel to one another and almost crosswise to the machine running direction, which were elevated 0.8 mm from the roller base and had a distance of 4 mm from one another. The distance between the lines, between the edge of one line until the next, following line was 3 mm, and the width of the lines or ridges was accordingly 1 mm. This resulted in a heat-bonding area of 25% relative to the total area expanse of the goods. In order to ensure sufficiently quiet running (no so-called chattering) during thermal calendering, the lines were not oriented precisely at a 90° angle to the machine running direction, but rather at an angle that deviated from this by 0.8°. In addition, the engraved calender roller was provided with so-called support edges, to additionally increase quiet running.

The three layers were passed through the calender pressing nip at a speed of 3 m/min and heat-bonded to one another as this happened. The temperature of the two calendering rollers was 142° C., in each instance, and the calender line force was 50 N/mm. The fiber sheet layer (a) with the coarse-titer 6.7 dtex fibers faced the engraved roller. After leaving the roller pressing nip, the goods were rolled up. No noticeable shrinkage of the goods was observed, so that a finished material weight of 58 g/m² was the result. The engraving contact side demonstrated slight waves, directed out of the plane into the third dimension, which were well suited as a loop medium for the hook part of the mechanical closure system.

The fine sheet side (b) was flat and smooth, because of its contact with the smooth roller, and imparted a soft, pleasant wearing feel on the skin, in part also because of its fine-titer fibers.

### EXAMPLE 2

The method of procedure in Example 2 was the same as in Example 1, but differed in that the staple fiber sheet of 1.7 dtex polypropylene fiber, having a weight of 8 g/m², was not included.

As is evident in Table 1, the properties changed only insignificantly, as compared with Example 1.

### EXAMPLE 3

In Example 3, the method employed was the same as in Example 2, but differed in that the slightly pre-embossed polypropylene nonwoven fabric having a weight of 20 g/m² was replaced with a variant having a weight of 30 g/m².

As is evident from the test data in the table, this enabled an increase in the strength crosswise to the machine running direction by about 50%.

The test results for Examples 1 to 3 are listed in Table 1. The finished material weights FMG were measured in g/m², the thickness in mm, the maximum tensile strength (HZK) in the lengthwise and crosswise direction in N/5 cm, the modulus at 10% expansion in the lengthwise and crosswise direction in N/5 cm, the peel strength in the crosswise direction in N/2.5 cm, and the shear strength in the crosswise direction in N/500 mm² of the nonwoven fabric laminate material. The weight per unit area FMG was determined according to EN 29073-01, the thickness according to EN ISO 9073-02, at a load of 500 Pa, and the maximum tensile strength HZK as well as the modulus according to EN 29073-03. The shear strength was determined according to ASTM D 5169-91 and the peel strength according to ASTM D 5170-91.

TABLE 1

[column headings:}
Example
FMG g/m²
Thickness mm
HZK N/5 cm, lengthwise, crosswise
Expansion at HZK %, lengthwise, crosswise
Modulus 10% N/5 cm, lengthwise, crosswise
Peel strength N/25 mm, crosswise
Shear strength N/500 mm², crosswise

What is claimed is:

1. A multi-layer nonwoven fabric laminate material comprising:
at least one layer of a polyolefin endless filament nonwoven fabric having a maximum tensile strength in a machine running direction that is at least as great as a maximum tensile strength in a crosswise direction as it is in the machine running direction, and that is made up essentially of fibers having a titer of less than 4.5 dtex;
a second layer of a nonwoven fabric that is bonded to the first layer, the second layer including a sheet of crimped staple fibers made of polyolefins, the crimped staple fibers being coarser than the fibers of the nonwoven fabric of the first layer, the at least two nonwoven fabric layers being bonded to one another at the common interface by bonding in the form of a pre-determined pattern.

2. The multi-layer nonwoven fabric laminate material according to claim 1, wherein the polyolefin endless filament nonwoven fabric is a polypropylene endless filament nonwoven fabric.

3. The multi-layer nonwoven fabric laminate material according to claim 1, wherein a ratio of the maximum tensile strength of the polyolefin endless filament nonwoven fabric in the machine running direction to the maximum tensile strength in a direction crosswise to the machine running direction is 1:1 to 2.5:1.

4. The multi-layer nonwoven fabric laminate material according to claim 1, wherein the titer of the fibers of the polyolefin endless filament nonwoven fabric is at least one of the ranges of 0.8 to 4.4 dtex and 1.5 to 2.8 dtex.

5. The multi-layer nonwoven fabric laminate material according to claim 1, wherein the crimped staple fibers of the second layer of the nonwoven fabric are at least one of two-dimensionally and spirally crimped.

6. The multi-layer nonwoven fabric laminate material according to claim 1, wherein the crimped staple fibers of the second layer of the nonwoven fabric have a titer in at least one of the ranges of 3.3 to 20 dtex and 5.0 to 12.0 dtex.

7. The multi-layer nonwoven fabric laminate material according to claim 1, wherein the crimped staple fibers of the sheet of the second nonwoven fabric layer are comprised of at least one of an olefin homopolymer, an olefin copolymer and a multi-component fibers with proportions of olefin homopolymer or copolymer, the crimped staple fibers making up at least 40% by weight of the fibers that form the second nonwoven fabric layer.

8. The multi-layer nonwoven fabric laminate material according to claim 1, wherein the first layer is bonded to the second layer of the nonwoven fabric by autogenic heat-bonding of the polyolefin fiber components of both layers at the common interface, in the form of a pre-determined pattern.

9. The multi-layer nonwoven fabric laminate material according to claim 8, wherein the autogenic heat-bonding is carried out by calendering.

10. The multi-layer nonwoven fabric laminate material according to claim 1, wherein the pre-determined pattern of the bonding has the form of at least one of non-intersecting and uninterrupted lines.

11. The multi-layer nonwoven fabric laminate material according to claim 10, wherein the total connection area is 18-32% of the total area.

12. The multi-layer nonwoven fabric laminate material according to claim 1, wherein the weight per unit area of the endless filament fiber layer is 25 to 45 g/m², and that a weight per unit area of the second nonwoven fabric layer is 20 to 50 g/m².

13. The multi-layer nonwoven fabric laminate material according to claim 1, wherein a weight per unit area of the nonwoven fabric laminate material has a total weight per unit area of at least one of the ranges of 30 to 130 g/m² and 45 to 95 g/m².

14. The multi-layer nonwoven fabric laminate material according to claim 1, wherein the laminate material, on a side of the first nonwoven fabric layer that lies opposite to the second nonwoven fabric layer, additionally has a staple fiber sheet of at least one of hydrophobic and hydrophobically activated crimped microfibers of at least one of polyolefins and bicomponent fibers with a polyolefin component.

15. A method for the producing a multi-layer nonwoven fabric laminate material, comprising the steps of:
producing a first layer of a polyolefin endless filament nonwoven fabric, having a maximum tensile strength in a machine running direction that is at least as great as a maximum tensile strength in a direction crosswise to the machine running direction;
producing a second layer of a nonwoven fabric, containing a sheet of crimped staple fibers of polyolefins, which are coarser than the fibers of the nonwoven fabric of the first layer; and
bonding the first and the second layers of the nonwoven fabrics at a common interface in a form of a pre-determined pattern.

16. The method according to claim 15, wherein the first layer of the polyolefin endless filament nonwoven fabric and the second layer of the nonwoven fabric are autogenically heat-bonded with one another by calendering with at least one calender roller pair made up of a heated smooth roller and a roller having a line engraving, the first layer of the polyolefin endless filament nonwoven fabric facing the smooth roller in the roller pressing nip, and the second layer of the nonwoven fabric facing the roller having a line engraving.

17. The method according to claim 16, wherein the calender rollers are heated to temperatures in the range of 110° C. to 155° C.

18. The method according to claim 16, wherein the roller engraved in line shape has engraving depths of 0.7 to 2.5 mm.

19. The multi-layer nonwoven fabric laminate material according to claim 1, wherein the multi-layer nonwoven fabric laminate material is configured to be used as a diaper.

20. The multi-layer nonwoven fabric laminate material according to claim 19, wherein the multi-layer nonwoven fabric laminate material is configured to be used as a diaper for adult incontinence patients.
